(19) United States
(12) Patent Application Publication
(10) Pub. No.: US 2008/0022582 A1
(43) Pub. Date: Jan. 31, 2008

(54) Fishing Line

(75) Inventors: Kojiro Hamano, Osaka (JP); Hiroshi Hirahata, Osaka (JP); Motomi Ohta, Mie (JP); Chizu Hasegawa, Mie (JP)

Correspondence Address: MORRISON & FOERSTER LLP, 1650 TYSONS BOULEVARD, SUITE 400, MCLEAN, VA, 22102, US

(73) Assignee: TOYO BOSEKI KABUSHIKI KAISHA, Osaka-shi, Osaka (JP)

(21) Appl. No.: 11/664,691

(22) PCT Filed: Sep. 28, 2005
(86) PCT No.: PCT/JP05/17837

§ 371 Date: Apr. 5, 2007

(30) Foreign Application Priority Data
Oct. 7, 2004 (JP) 2004-295037

(51) Int. Cl. A01K 91/00

(52) U.S. Cl. 43/44.98

(57) ABSTRACT

A novel, low cost fishing line resolves various problems posed by conventional fishing lines of braided structure, such as breaking strength, knot strength, low breaking elongation, drape insufficiency and producible length. The fishing line is made up of multiple filaments bound and united by means of a water dispersible resin adhesive. This fishing line realizes reduction of yarn damaging though avoidance of knitting and braiding steps, having such a structure that, due to buildup with enhanced linearity, the inherent strength of fiber can be easily exploited and the structure can be made with high productivity.

### REFERENCE TO RELATED APPLICATION

This application is a national stage application under 35 USC 371 of International Application No. PCT/JP2005/017837, filed Sep. 28, 2005, which claims priority from Japanese Patent Application No. 2004-295037, filed Oct. 7, 2004, the entire contents of which are incorporated herein by reference.

### FIELD OF THE INVENTION

The present invention relates to a high performance fishing line used widely for fishery and recreation fishing, to which very high breaking strength, high knot strength, very law breaking elongation, high abrasion resistance, high dimensional stability and durability are required.

### BACKGROUND OF THE INVENTION

A fishing line includes, for example, fishing line for reels which is used in the state of being wound on a reel, fishing line for lure, fishing line for flying, fishing line for fishing in mountain stream, fishing line for sweet fish fishing, decoy line, leader line or the like. Characteristic required commonly to these fishing lines are lightness in weight, high strength, and durability required to maintain these characteristics for a long period. As a result of the development of a fiber having a strength of more than 20 g/d, a fishing line comprising the high strength fiber became widely used particularly in deep sea fishing, fishing on a boat or the like. Such a fishing line is generally produced by braiding into a braid configuration such as three-strand, four-strand, eight-strand, sixteen-strand or thirty-two-strand configuration, followed by coating with any resin. As the fiber, a high strength polyethylene fiber is mainly used alone. Refer to, for example, Patent Document 1.

Patent Document 1: Japanese Unexamined Patent Publication (Kokai) No. 8-140538.

### BRIEF DESCRIPTION OF THE DRAWINGS

FIG. 1 is a schematic view showing an apparatus for evaluating abrasion resistance.

### SUMMARY OF THE INVENTION

In leisure fishing which has been popularizing more and more, a demand of higher performances and cost reduction for a fishing line has been increasing. This depends on the following problems in practical use, which arises in a fishing line having a braid structure of a four-strand, eight-strand or sixteenth-strand configuration, comprising only a high strength fiber (nylon, polyethylene, etc.) which is widely used in such an application.
(1) A fishing line having a braid structure is widely used in fishing on a boat or the like. However, the fishing line is likely to cause surface irregularity and to be broken because of poor elasticity. Therefore, in the application such as surf-fishing which requires form stability, namely, sufficient elasticity required as a fishing line, a fishing line comprising an existing braid causes problems such as entanglement of the fishing line and poor handling of the fishing line and thus it cannot satisfy the requirements.
(2) Although a filament exhibits the highest strength when used in a linear state, a high strength fiber is not used in a linear state in a braid structure. Therefore, mechanical properties such as high breaking strength, knot strength and low elongation of the fiber can not be completely exhibited and thus a utilization rate of strength is low.
(3) If the elasticity needs to be enhanced by the braid structure, a braid pitch of the braid must be decreased inevitably and the filament is bended at a large angle, thus causing a decrease in a breaking strong and an increase in a breaking elongation.
(4) Since only a braid having a length which can be wound around a spool, which is used in the production of the braid, can be continuously produced, only a short fishing line can be obtained.
(5) Since a braid is inferior in productivity and it is impossible to reduce the processing cost, the cost for such fishing line is high.

The present invention has been made so as to solve the above problems of the prior arts. That is, an object of the present invention is to provide a long fishing line which has excellent mechanical properties such as high breaking strength, high knot strength and low breaking elongation as compared with a fishing line having a braid structure comprising a high strength fiber, and also has sufficient elasticity and is excellent in productivity.

The present inventors have intensively studied so as to achieve the above described object, and thus the present invention has been completed.

That is, the present invention provides a fishing line comprising plural filaments which are bundled with the use of a water dispersible resin and integrated after being dried.

One aspect of the present invention is the fishing line that is characterized in that a high strength polyethylene fiber having a breaking strength of 15 cN/dtext or more, a breaking elongation of 6% or less, an initial elastic modulus of 500 cN/dtex or more is used as the main portion of the constituent filaments.

Another aspect of the present invention is the fishing line wherein the water dispersible resin contains 50 mol % or more of an ethylene-based resin composition.

Also another aspect of the present invention is the fishing line wherein the water dispersible resin is a copolymer resin composition of an ethylene-based resin and an unsaturated carboxylic acid-based resin.

Further aspect of the present invention is the fishing line wherein the water dispersible resin is resin dispersed in an aqueous alkaline solution.

Another aspect of the present invention is the fishing line wherein the aqueous alkaline solution is a solution containing ammonia.

Yet another aspect of the present invention is the fishing line wherein an organic crosslinking agent is used in combination with the water dispersible resin.

Further aspect of the present invention is the fishing line wherein polyvalent metal ions are used in combination with the water dispersible resin.

Another aspect of the present invention is the fishing line wherein the constituent filaments are twisted at a twist coefficient within a range from 0.2 to 2.0 in one direction.

The present invention can provide a fishing line which has excellent mechanical properties such as high breaking strength, high knot strength and low breaking elongation, with the use of inherent performances of a high strength fiber effectively, and also has sufficient elasticity and sufficient length with excellent productivity.

### DETAILED DESCRIPTION OF THE INVENTION

The main portion of a filament constituting the present invention is preferably composed of a high strength polyethylene fiber. The high strength polyethylene fiber in the present invention preferably has a breaking strength of 15 cN/dtext or more, thus high strength on breakage, an elongation of 6% or less, and an initial elastic modulus of 500 cN/dtex or more. When the elongation and initial elastic modulus are within the above range, the resulting fishing line has high performances because a response in case of hooking-up a fish is directly transferred to a fisherman, satisfactorily.

The high strength polyethylene fiber satisfying above various characteristics is also excellent in durability such as abrasion resistance, dimensional stability and light resistance.

It is necessary that the filament must be chemically stable and the strength does not decrease during a treatment in order to perform a treatment using a water soluble resin and to perform a treatment such as crosslinking. Since the fiber made of an ultrahigh molecular weight polyethylene is extremely stable chemically, it is preferably utilized in the present invention. Therefore, the constituent filament preferably contains the high strength polyethylene fiber in an amount of 60% by weight or more, and more preferably 90% by weight or more.

The method of obtaining such a high strength polyethylene fiber includes, for example, well known methods disclosed in Japanese Unexamined Patent Publication (Kokai) Nos. 59-216912, 59-216913, 59-216914, 60-45630, 60-52647, 60-52613, 60-59172, 60-151311, and Japanese Examined Patent Publication (Kokoku) 3-57964.

The water dispersible resin used in the present invention is preferably an ethylene-based resin composition obtained by copolymerizing an olefinic component having 4 or less carbon atoms, such as ethylene or propylene so as to obtain high adhesion with the above described high strength polyethylene fiber. Furthermore, the content of the ethylene-based resin composition in the resin component is preferably 50 mol % or more, more preferably 70 mol % or more, and particularly preferably 80 mol % or more.

Since the ethylene-based resin composition is a main constituent component, the water dispersible resin of the present invention has excellent abrasion resistance and light resistance after drying, and also exhibits excellent durability as a resin for fishing line used in severe environment.

The water dispersible resin used in the present invention is more preferably a copolymer resin composition of an ethylene-based resin and an unsaturated carboxylic acid-based resin. The above resin has high affinity with the ultrahigh molecular weight polyethylene fiber and affinity with a solvent (water, alcohol), and also penetrates deeply into the space between filaments of the ultrahigh molecular weight polyethylene fiber, coats on the surface of the filament and firmly adheres after drying, thus securing high water resistance.

In other words, the use of the above copolymer resin composition makes it possible to easily bundle filaments of the ultrahigh molecular weight polyethylene fiber, which was conventionally considered to be difficult, and to bond on the surface of the fiber, thus integrating the filaments.

The amount of the unsaturated carboxylic acid-based component in the above copolymer resin composition is preferably within a range from 1 to 50 mol %, more preferably from 2 to 30 mol %, and particularly preferably from 3 to 20 mol %. The amount of the unsaturated carboxylic acid-based component shows the total amount of the unsaturated carboxylic acid and the ester thereof.

As the component constituting the unsaturated carboxylic acid, components such as acrylic acid and methacrylic acid can be effectively used, and may also contain an ester such as acrylate ester or methacrylate ester.

As the ester, an ester of an alcohol having 4 or less carbon atoms can preferably be used, and methyl ester and ethyl ester are particularly preferably used.

Since the water dispersible resin used in the present invention is coated on the surface of each filament and also penetrates deeply into the space between filaments because of good affinity with the constituent ultrahigh molecular weight polyethylene fiber, high adhesion is obtained. This water dispersible resin is ideally used as an aqueous solution, and also can be used in a water/alcohol solution or an alcohol solution. Methanol, ethanol and isopropyl alcohol can preferably used as the alcohol.

The viscosity of the water dispersible resin used in the present invention is 2,000 mPa·s or less, preferably 500 mPa·s or less, and more preferably 250 mPa·s or less, so that the water dispersible resin preferably penetrates into the space between filaments of the ultrahigh molecular weight polyethylene fiber.

The viscosity is preferably 5 mPa·s or more so as to sufficiently secure adhesion to the surface of the filament.

To disperse and dissolve the resin of the present invention, it is effective to use an alkali solution and thus an aqueous alkali solution is preferable.

Examples of the alkali include ammonia, amine, sodium hydroxide and potassium hydroxide. When ammonia is used, the water dispersible resin is satisfactorily dispersed in water and it becomes possible to use a high concentration dispersion solution. Also, when ammonia is vaporized in the drying process, deposition of the after dispersible resin is promoted and a coating film having higher water resistance is obtained.

Furthermore, in order to increase water resistance and strength of the coating film, a crosslinking agent and a polyvalent metal ion may be added.

As the crosslinking agent, epoxy-based, isocyanate-based, aziridine-based and oxazoline-based crosslinking agents can be used. Especially, a polymer having an oxazoline group in the side chain of the polymer can produce an amide ester through the reaction with a polymer having a carboxyl group at low temperature, thus forming a crosslinked structure.

As described above, the crosslinking agent of the present invention reacts with a functional group as a reactive functional group represented by a carboxyl group (also with a hydroxyl group, a sulfonic acid group, etc.) to form an intermolecular or intramolecular crosslinked structure.

The polyvalent metal ion includes, for example, zinc, magnesium and calcium ions. In case of zinc, the water dispersible resin is adhered on the filament in the form of a sodium salt, followed by immersion of the filament in an aqueous saturated solution of zinc chloride so that an ion exchange reaction proceeds. As a result, zinc ions are ionically bonded with a plurality of ionized carboxyl groups, thus exerting the crosslinking effect similar to that of the above crosslinking agent.

If necessary, acrylic acid resin, urethane resin, polyester resin, polyolefin resin, rosin-based resin, terpene-based resin, phenol-based resin, petroleum-derived resin, paraffin, paraffin oxide, polyethylene oxide, and ethylene-acrylic acid copolymer wax can be appropriately added alone or used in combination.

The fishing line of the present invention can be obtained by impregnating or coating a multifilament comprising a plurality of fibers with the above water dispersible resin in the state of being twisted preferably, followed by drying.

Suitable count of twists to the filament depends on fineness (thickness) of the fiber used and is therefore represented by a twist coefficient defined by the following equation:

$$Twist coefficient = \frac{tpm}{3025} \sqrt{\frac{dtex}{ρ}}$$

wherein tpm denotes the number of turn per meter, and p denotes a specific gravity (g/cm³).

Suitable twist coefficient in the present invention is within a range from 0.2 to 2.0. If the twist coefficient is less than 0.2, the filament is likely to be loosened into fibers due to external abrasion. It is not preferable because the section of the filament is likely to become flat.

If the twist coefficient exceeds 2.0, it becomes impossible to exhibit intrinsic strength of the high strength fiber because a twist angle becomes too large, resulting in decreased breaking strength, and therefore it is not preferable.

As the method of coating with a resin, an existing method such as dip coating method, knife coating method, roller coating method or curtain flow coating method can be employed but is not specifically limited. The drying method is not also specifically limited and drying can be continuously performed using a hot air tank. The drying temperature is within a range from 100 to 200° C. in an atmospheric air and the air temperature directly put on the filament is preferably lower than 160° C.

In the present invention, as the method of coating the twisted constituent filament with the water dispersible resin, a known method may be used. For example, the filament of the present invention can be produced by passing filaments of the present invention through a bath at room temperature, for example, about 25 to 30° C., which contains a water dispersible resin liquid, and then passed through a furnace kept at a temperature of about 100 to 150° C., thereby sufficiently dried.

In the case where a colored fishing line is required, it is possible to mix the water dispersible resin of the present invention with a pigment which is necessary for desired color development.

The amount of the resin adhered is preferably within a range from 3 to 30% by weight, and more desirable from 10 to 25% by weight, based on the weight of the filament after being dried. When the amount of the resin exceeds 30% by weight, handling properties required for a fishing line deteriorate. On the other hand, when the amount of the resin is less than 3% by weight, fixation of the filament may become insufficient.

### EXAMPLES

Examples of the present invention will now be described. Needless to say, the present invention is not limited to the examples.

### Example 1

A high strength polyethylene fiber (breaking strength: 26 cN/dtex) DAINEEMA (Registered Trademark) SK60 (20 dtex/192 F) was twisted 300 times per meter in an S direction, passed through a bath at about 25° C., which contains a water dispersible ethylene/unsaturated carboxylic acid-based copolymer resin (manufactured by Ohta Kaken Co., Ltd. under the trade name of NC-20A; pH=8.5; resin solid content=20% by weight), and then passed through a furnace kept at a temperature of 110° C. at a rate of 30 m/min for 30 seconds.

### Example 2

DAINEEMA (Registered Trademark) SK60 (110 dtex/96 F) was twisted 400 times per meter in an S direction, passed through a bath at about 25° C., which contains an ethylene/unsaturated carboxylic acid-based copolymer resin (manufactured by Ohta Kaken Co., Ltd. under the trade name of NC-20A), and then passed through a furnace kept at a temperature of 140° C. at a rate of 30 m/min for 30 seconds.

### Example 3

DAINEEMA (Registered Trademark) SK60 (110 dtex/96 F) was twisted 400 times per meter in an S direction, passed through a bath at about 25° C., which contains an ethylene/unsaturated carboxylic acid-based copolymer resin (manufactured by Ohta Kaken Co., Ltd. under the trade name of NC-20A) and 10% of an oxazoline-based crosslinking agent based on the solid content of the copolymer resin (manufactured by Nippon Shokubai Co., Ltd. under the trade name of EPOCROSS WS-500), and then passed through a furnace kept at a temperature of 140° C. at a rate of 30 m/min for 30 seconds.

### Comparative Example 1

DAINEEMA (Registered Trademark) SK60 (220 dtex/192 F) was twisted 300 times per meter in an S direction, passed through a bath at about 25° C., which contains a resin prepared by mixing 100 parts by weight of a bisphenol A type epoxy resin EPICOAT 828 manufactured by YUKA SHELL (Japan Epoxy Resins Co., Ltd.) with 24 parts by weight of an amine-based curing agent EPOMATE RD 1, and then passed through a furnace kept at a temperature of 130° C. at a rate of 5 m/min for 5 minutes.

### Comparative Example 2

DAINEEMA (Registered Trademark) SK60 (220 dtex/192 F) was twisted 300 times per meter in an S direction, and then coated with a melt of a low molecular weight polyethylene (manufactured by Ube Industries, Ltd., test method defined in JIS K7210, MFR50) while feeding through a cross head die.

### Comparative Example 3

Using four DAINEEMA (Registered Trademark) SK60 (110 dtex/96 F), a four-strand braided cord was produced without coating with a resin.

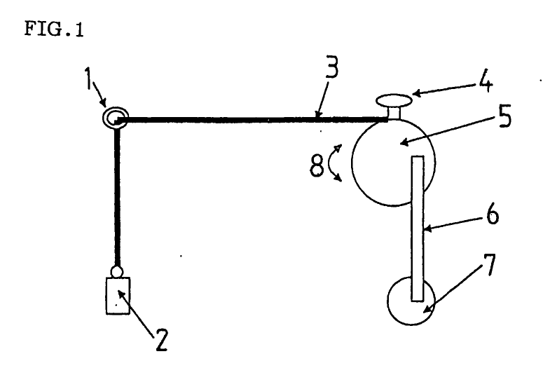

A testing machine used in an abrasion resistance test was a modified hexagonal bar abrasion test for seat belt shown in FIG. 1, in which a ceramic guide having a diameter of 9 mm is disposed at the position of the hexagonal bar. A stroke length and an angle are as defined in JIS-D-4604 (1995).

As described in FIG. 1, a sample is put on a ceramic guide and one end is fixed to the drum, while a load is applied on the other end. The load is 1.1 cN/Tex. The number of times on breakage was evaluated as abrasion resistance. Furthermore, abrasion resistance was evaluated whether or not fuzz occurs after reciprocating the drum 1,000 times.

The evaluation results are shown in Table 1.

TABLE 1

| | | Evaluation results | | | | | | |
|---|---|---|---|---|---|---|---|---|
| Evaluation | | | | | Comparative | Comparative | Comparative | Evaluation |
| items | Unit | Example 1 | Example 2 | Example 3 | Example 1 | Example 2 | Example 3 | method |
| Fineness of | dtex | 247 | 120 | 135 | 256 | 336 | 411 | As defined in |
| fishing line | | | | | | | | JIS L 1013 |
| Amount of | % by | 12.3 | 9.1 | 22.7 | 16.4 | 52.7 | 0 | Based on |
| resin adhered | weight | | | | | | | weight of |
| | | | | | | | | filaments |
| Breaking | CN/dtex | 25.9 | 25.1 | 27.1 | 24.1 | 8.3 | 21.7 | As defined in |
| strength | | | | | | | | JIS L 1013 |
| Blank | dtex | 28.0 | 28.0 | 28.0 | 28.0 | 28.0 | 28.0 | |
| strength | | | | | | | | |
| Utilization rate | (%) | 92.3 | 89.6 | 96.8 | 86.1 | 65.3 | 77.5 | |
| Breaking | % | 4.57 | 4.23 | 4.21 | 4.26 | 4.47 | 4.45 | |
| elongation | | | | | | | | |
| Bundling | | ∘ | ∘ | ∘ | ∘ | Δ | Δ | |
| properties | | | | | | | | |
| Elasticity | | ∘ | ∘ | ∘ | Δ | ∘ | x | |
| Abrasion | Number | 69,030 | 50,400 | 65,350 | 6,400 | 5,930 | 30,450 | Testing |
| resistance | of times | ∘ | ∘ | ∘ | x | x | Δ | machine |
| | | | | | | | | (FIG. 1) |

* Utilization rate is a numerical value which is obtained through dividing a breaking strength by a blank strength, namely, a flat yarn strength of a filament before processing, and represents deterioration of physical properties caused by processing.

(Utilization Rate)

In the table, a utilization rate is a numerical value which is obtained through dividing a breaking strength by a blank strength, namely, a flat yarn strength of a filament before processing, and represents deterioration of physical properties caused by processing.

(Bundling Properties)

◯: good
Δ: easy to be loosened because of insufficient bundling properties
×: bad
   (Elasticity)
◯: good
Δ: usable, but poor
×: unsuited for use
   (Abrasion Resistance)
◯: sufficient durability
Δ: slightly poor durability
×: scarcely fit for use

1. A fishing line comprising multiple filaments which are bundled with a water dispersible resin and integrated after being dried.

2. The fishing line according to claim 1, wherein the constituent filaments of the fishing line consist essentially of a high strength polyethylene fiber having a breaking strength of 15 cN/dtext or more, a breaking elongation of 6% or less, and an initial elastic modulus of 500 cN/dtex or more.

3. The fishing line according to claim 1 or 2, wherein the water dispersible resin contains 50 mol % or more of an ethylene-based resin composition.

4. The fishing line according to claim 1, wherein the water dispersible resin is a copolymer resin composition of an ethylene-based resin and an unsaturated carboxylic acid-based resin.

5. The fishing line according to claim 1, wherein the water dispersible resin is a resin dispersed in an aqueous alkaline solution.

6. The fishing line according to claim 5, wherein the aqueous alkaline solution is a solution containing ammonia.

7. The fishing line according to claim 1, wherein an organic crosslinking agent is used in combination with the water dispersible resin.

8. The fishing line according to claim 1, wherein polyvalent metal ions are used in combination with the water dispersible resin.

9. The fishing line according to claim 1, wherein the constituent filaments are twisted at a twist coefficient within a range from 0.2 to 2.0 in one direction.

10. The fishing line according to claim 3, wherein the water dispersible resin is a copolymer resin composition of an ethylene-based resin and an unsaturated carboxylic acid-based resin.

11. The fishing line according to claim 10, wherein the water dispersible resin is a resin dispersed in an aqueous alkaline solution.

12. The fishing line according to claim 3, wherein an organic crosslinking agent is used in combination with the water dispersible resin.

13. The fishing line according to claim 3, wherein polyvalent metal ions are used in combination with the water dispersible resin.

14. The fishing line according to claim 3, wherein the constituent filaments are twisted at a twist coefficient within a range from 0.2 to 2.0 in one direction.

15. The fishing line according to claim 4, wherein the water dispersible resin is a copolymer resin composition of an ethylene-based resin and an unsaturated carboxylic acid-based resin.

16. The fishing line according to claim 15, wherein the water dispersible resin is a resin dispersed in an aqueous alkaline solution.

17. The fishing line according to claim 4, wherein an organic crosslinking agent is used in combination with the water dispersible resin.

18. The fishing line according to claim 4, wherein polyvalent metal ions are used in combination with the water dispersible resin.

19. The fishing line according to claim 4, wherein the constituent filaments are twisted at a twist coefficient within a range from 0.2 to 2.0 in one direction.
